(19) United States
(12) Patent Application Publication
(10) Pub. No.: US 2011/0280321 A1
(43) Pub. Date: Nov. 17, 2011

(54) DEBLOCKING FILTER AND METHOD FOR CONTROLLING THE DEBLOCKING FILTER THEREOF

(76) Inventor: Shu-Hsien Chou, Tainan County (TW)

(21) Appl. No.: 12/778,134

(22) Filed: May 12, 2010

(51) Int. Cl. H04N 7/26

(52) U.S. Cl. 375/240.29; 375/E07.193

(57) ABSTRACT

A deblocking filter includes a controller, an edge filter module, a first multiplexer module, a plurality of buffers, and a second multiplexer module. The controller controls the deblocking filter to filter edges between decoded blocks according to a plurality of deblocking strategies in order to obtain an efficiency result under a designated video standard, and determines a target deblocking strategy by reference to the efficiency result. The edge filter module filters a plurality of original pixels to generate a plurality of filtered pixels. The first multiplexer module outputs a plurality of combinations selected from the plurality of filtered pixels according to the target deblocking strategy. The plurality of buffers are used for storing the plurality of combinations, respectively. The second multiplexer module selectively outputs a designated combination of the plurality of combinations as the original pixels to be inputted into the edge filter module according to the target deblocking strategy.

### BACKGROUND OF THE INVENTION

1. Field of the Invention

The present invention relates to a deblocking filter and a related controlling method, and more particularly, to a deblocking filter and a related controlling method for determining an optimized deblocking strategy under a designated video standard in order to obtain an improved deblocking performance as well as an efficient buffer size.

2. Description of the Prior Art

A multi-format video decoder is capable of supporting various kinds of video standards, such as an MPEG-2 specification, an MPEG-4 specification, a VC-1 specification, an H.264/AVC specification, a RMVB specification, or an AVS specification. In general, a deblocking filter is applied to decoded blocks/decoded macroblocks in order to reduce blocking distortion. The deblocking filter can smooth edges between decoded blocks/decoded macroblocks to improve the appearance of decoded frames, such that compression performance can be improved.

Typically, edge filter(s) and buffer(s) are most critical components for the deblocking filter. That is to say, the edge filter (s) and the buffer(s) occupy most of chip areas within the deblocking filter and result in the greatest impact on the deblocking performance of the deblocking filter.

Hence, how to save the chip area of the deblocking filter and how to improve the deblocking performance of the deblocking filter for the multi-format video decoder have become an important topic of the field.

### SUMMARY OF THE INVENTION

It is one of the objectives of the claimed invention to provide a deblocking filter and a related method to solve the abovementioned problems.

According to one embodiment, a deblocking filter is provided. The deblocking filter includes a controller, an edge filter module, a first multiplexer module, a plurality of buffers, and a second multiplexer module. The controller controls the deblocking filter to filter a plurality of edges between decoded blocks according to a plurality of deblocking strategies in order to obtain an efficiency result under a designated video standard, and determines a target deblocking strategy from the plurality of deblocking strategies by reference to the efficiency result. The edge filter module is coupled to the controller, for filtering a plurality of original pixels to generate a plurality of filtered pixels. The first multiplexer module is coupled to the edge filter module and the controller, for receiving the plurality of filtered pixels fed back from the edge filter module, and for outputting a plurality of combinations selected from the plurality of filtered pixels according to the target deblocking strategy. The plurality of buffers are coupled to the first multiplexer module, for storing the plurality of combinations, respectively. The second multiplexer module is coupled to the plurality of buffers, the edge filter module, and the controller, for selectively outputting a designated combination of the plurality of combinations as the original pixels to be inputted into the edge filter module according to the target deblocking strategy.

According to another embodiment, a method for controlling a deblocking filter is provided. The method includes steps of: controlling the deblocking filter to filter a plurality of edges between decoded blocks according to a plurality of deblocking strategies in order to obtain an efficiency result under a designated video standard; determining a target deblocking strategy from the plurality of deblocking strategies by reference to the efficiency result; receiving a plurality of filtered pixels, and outputting a plurality of combinations selected from the plurality of filtered pixels according to the target deblocking strategy; storing the plurality of combinations, respectively; selectively outputting a designated combination of the plurality of combinations as a plurality of original pixels according to the target deblocking strategy; and filtering the plurality of original pixels to generate the plurality of filtered pixels.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating vertical edges and horizontal edges between decoded blocks.

FIG. 2 is a block diagram illustrating an architecture of a deblocking filter according to an embodiment of the present invention.

FIG. 3 is a diagram showing an exemplary embodiment of the controller shown in FIG. 2.

FIG. 4 (including 4A and 4B) is a diagram illustrating a deblocking strategy for deblocking edges under a designated video standard according to an embodiment of the present invention.

FIG. 5 is a flowchart illustrating a method for controlling a deblocking filter according to an exemplary embodiment of the present invention.

### DETAILED DESCRIPTION

Certain terms are used throughout the following description and claims to refer to particular components. As one skilled in the art will appreciate, hardware manufacturers may refer to a component by different names. This document does not intend to distinguish between components that differ in name but in function. In the following discussion and in the claims, the terms “include”, “including”, “comprise”, and “comprising” are used in an open-ended fashion, and thus should be interpreted to mean “including, but not limited to . . . ”. The terms “couple” and “coupled” are intended to mean either an indirect or a direct electrical connection. Thus, if a first device couples to a second device, that connection may be through a direct electrical connection, or through an indirect electrical connection via other devices and connections.

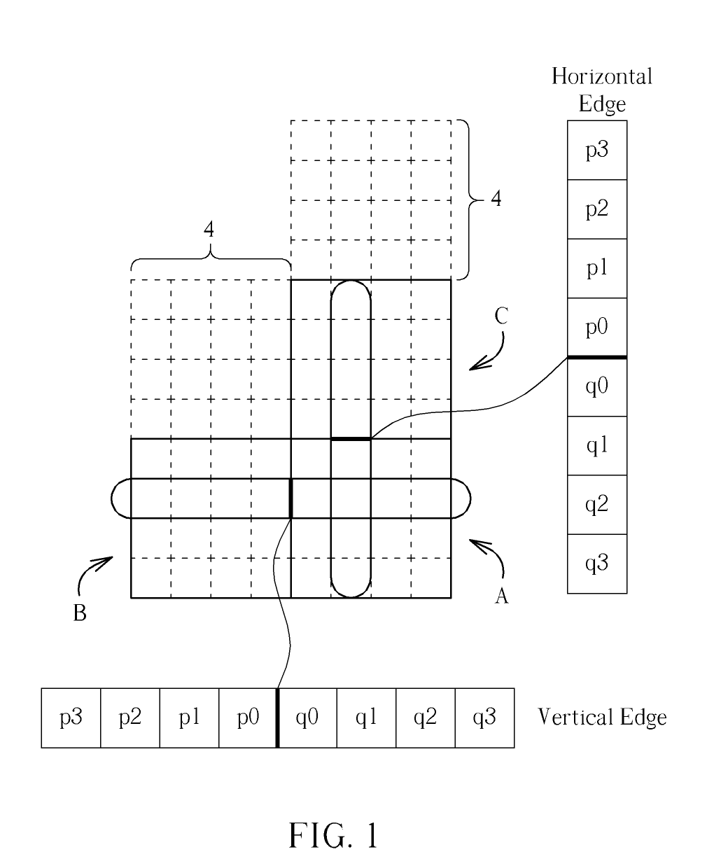

First, in order to make the specification of the present invention easy to understand, a brief description of the algorithm of a deblocking filter is given as below. FIG. 1 is a diagram illustrating vertical edges and horizontal edges between decoded blocks. As FIG. 1 depicts, each of decoded blocks A, B, and C is a 4×4 block, wherein edges are existed between any two of the decoded blocks. For example, a vertical edge is existed between the decoded block B (including a plurality of original pixels p0, p1, p2, and p3) and the decoded block A (including a plurality of original pixels q0, q1, q2, and q3); and a horizontal edge is existed between the decoded block C (including a plurality of original pixels p0, p1, p2, and p3) and the decoded block A (including a plurality of original pixels q0, q1, q2, and q3). As is already known to one skilled in the art, a deblocking filter is capable of filtering vertical edges or horizontal edges between decoded blocks, so as to give a higher subjective visual quality. In details, the deblocking filter may filter the plurality of original pixels p0˜p3 and q0˜q3 to generate a plurality of filtered pixels (e.g., p0′˜p3′ and q0′˜q3′), and thus the filtered pixels p0′˜p3′ and q0′˜q3′ can be used to redefine the original pixels p0˜p3 and q0˜q3.

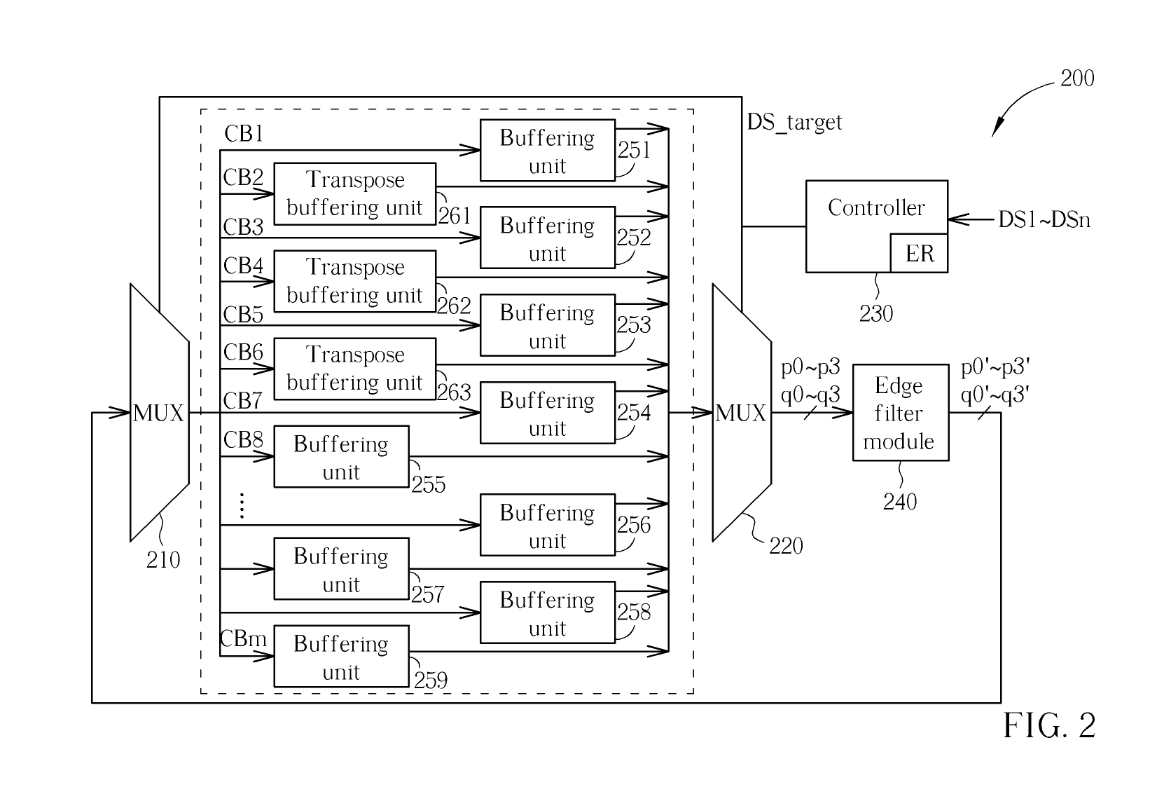

FIG. 2 is a block diagram illustrating an architecture of a deblocking filter 200 according to an embodiment of the present invention. As shown in FIG. 2, the deblocking filter 200 includes, but is not limited to, a controller 230, an edge filter module 240, a first multiplexer module 210, a plurality of buffers 251˜259 and 261˜263, and a second multiplexer module 220. What calls for special attention is that the controller 230 controls the deblocking filter 200 to filter a plurality of edges between decoded blocks according to a plurality of deblocking strategies DS1-DSn in order to obtain an efficiency result ER under a designated video standard, and then determines a target deblocking strategy DS_target from the plurality of deblocking strategies DS1-SDn by reference to the efficiency result ER.

Furthermore, the edge filter module 240 is coupled to the controller 230, for filtering a plurality of original pixels (including p0˜p3 and q0˜q3) to generate a plurality of filtered pixels (including p0′˜p3′ and q0′˜q3′). The first multiplexer module 210 is coupled to the edge filter module 240 and the controller 230, for receiving the plurality of filtered pixels p0′˜p3′ and q0′˜q3′ fed back from the edge filter module 240, and for outputting a plurality of combinations CB1-CBm selected from the plurality of filtered pixels p0′˜p3′ and q0′˜q3′ according to the target deblocking strategy DS_target. The plurality of buffers 251˜259 and 261˜263 are coupled to the first multiplexer module 210, for storing the plurality of combinations CB1-CBm, respectively. Moreover, the second multiplexer module 220 is coupled to the plurality of buffers 251˜259 and 261˜263, the edge filter module 240, and the controller 230, for selectively outputting a designated combination of the plurality of combinations CB1˜CBm as the original pixels p0˜p3 and q0˜q3 to be inputted into the edge filter module 240 according to the target deblocking strategy DS_target.

In this embodiment, the plurality of buffers are implemented by a plurality of buffering units 251˜259 and a plurality of transpose buffering units 261˜263. As the name implies, the buffering units 251˜259 are used for storing non-transposed data of the plurality of filtered pixels p0′˜p3′ and q0′˜q3′, while the transpose buffering units 261˜263 are used for storing transposed data of the plurality of filtered pixels p0′˜p3′ and q0′˜q3′. However, this in no way should be considered as limitations of the present invention. Those skilled in the art should appreciate that the number and the type of the buffers are not limited.

Please note that, in this embodiment, only the second multiplexer module 220 is adopted for outputting the original pixels p0˜p3 and q0˜q3 to be inputted into the edge filter module 240, but the present invention is not limited to this only. In other embodiment, the second multiplexer module 220 may further have two multiplexing units. Herein one multiplexing unit is used for generating the original pixels p0˜p3 of a reference decoded block, and the other one multiplexing unit is used for generating the original pixels q0˜q3 of a current decoded block, which also belongs to the scope of the present invention.

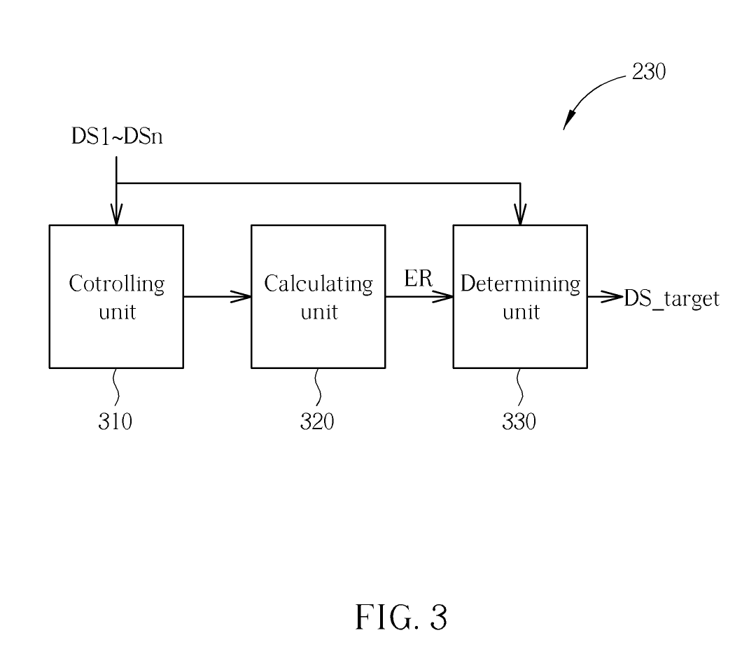

Please refer to FIG. 3. FIG. 3 is a diagram showing an exemplary embodiment of the controller 230 shown in FIG. 2. As shown in FIG. 3, the controller 230 includes a controlling unit 310, a calculating unit 320, and a determining unit 330. The controlling unit 310 controls the deblocking filter 200 to filter the plurality of edges between decoded blocks according to the plurality of deblocking strategies DS1˜DSn under the designated video standard. After all of the plurality of edges between decoded blocks are filtered according to the plurality of deblocking strategies DS1˜DSn, the calculating unit 320 calculates the efficiency result ER. The determining unit 330 is coupled to the calculating unit 320, for determining the target deblocking strategy DS_target from the plurality of deblocking strategies DS1˜DSn by reference to the efficiency result ER.

The abovementioned embodiment is merely a practicable embodiment of the present invention, and is not meant to be limitations of the scope of the present invention. Certainly, people skilled in the art will readily appreciate that other designs for implementing the controller 210 are feasible without departing from the scope of the present invention.

Please also note that the deblocking filter 200 disclosed in the present invention can be applied to a multi-format video decoder supporting a plurality of video standards. Moreover, the video standards may include an MPEG-2 specification, an MPEG-4 specification, a VC-1 specification, an H.264/AVC specification, a RMVB specification, or an AVS specification, but this should not be considered as a limitation of the present invention.

What calls for special attention is that each of the plurality of deblocking strategies DS1˜DSn indicates a processing order for deblocking the plurality of edges between the decoded blocks. Additionally, the controller 230 determines different target deblocking strategies DS_target under various kinds of video standards. Detailed operations of the deblocking strategies DS1˜DSn will be illustrated in the following embodiments.

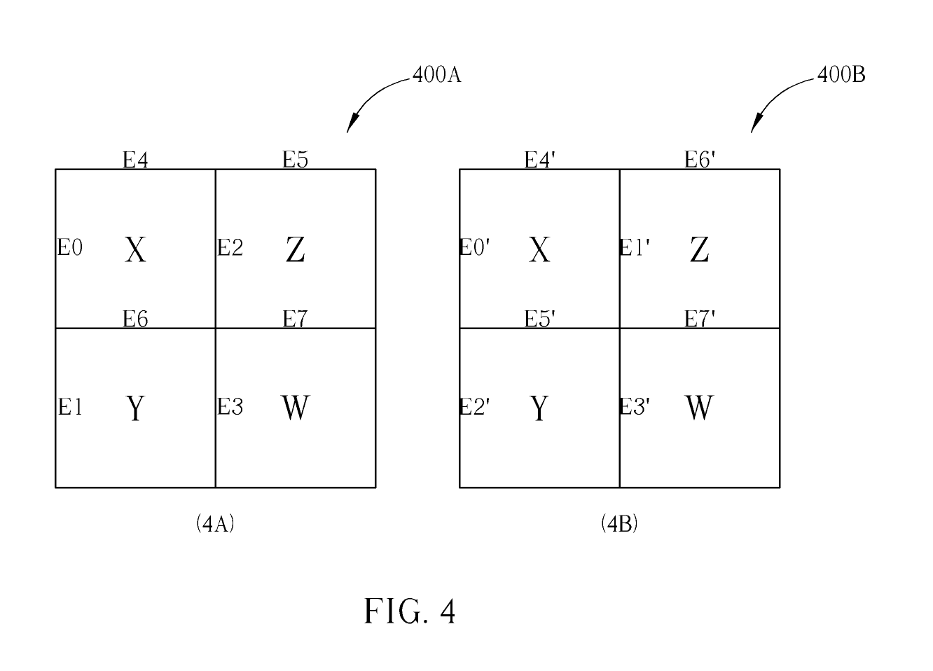

Please refer to FIG. 4. FIG. 4 (including 4A and 4B) is a diagram illustrating a deblocking strategy for deblocking edges under a designated standard according to an embodiment of the present invention. As shown in 4A, a macroblock 400A includes four decoded blocks W, X, Y, and Z, and there are totally eight edges E0˜E8 needed to be deblocked. In this first case, the eight edges E0˜E8 are sequentially deblocked according to the first deblocking strategy; that is to say, the first deblocking strategy can be represented by a processing order: E0→E1→E2→E3→E4→E5→E6→E7. As shown in 4B, a macroblock 400B includes four decoded blocks W, X, Y, and Z, and there are totally eight edges E0′˜E8′ needed to be deblocked. In this second case, the eight edges E0′˜E8′ are sequentially deblocked according to the second deblocking strategy; that is to say, the second deblocking strategy can be represented by a processing order: E0′→E1′→E2′→E3′→E4′→E5′→E6′→E7′.

As can be seen from 4A and 4B, since the first deblocking strategy and the second deblocking strategy have different processing orders for deblocking edges, the original pixels p0˜p3 and q0˜q3 to be inputted into the edge filter module 240 are different in these two cases. As a result, the combinations CB1˜CBm stored in the plurality of buffers 251˜259 and 261˜263 are different from each other when the controller 230 adopts different deblocking strategies to filter the edges. As is already known to one skilled in the art, the edge filter module 240 and the buffers 251˜259 and 261˜263 occupy most of chip areas within the deblocking filter 200 and result in the greatest impact on the deblocking performance of the deblocking filter 200. In other words, the chip areas occupied by the buffers 251˜259 and 261˜263 as well as the deblocking performance of the deblocking filter 200 will vary depending on different deblocking strategies. For this reason, after the deblocking filter 200 filters the edges between decoded blocks according to the plurality of deblocking strategies DS1-DSn in order to obtain the efficiency result ER under a designated video standard, the controller 230 is capable of determining a target deblocking strategy DS_target by reference to the efficiency result ER. Therefore, not only can the chip area of the deblocking filter 200 be saved, but the deblocking performance of the deblocking filter 200 can also be optimized.

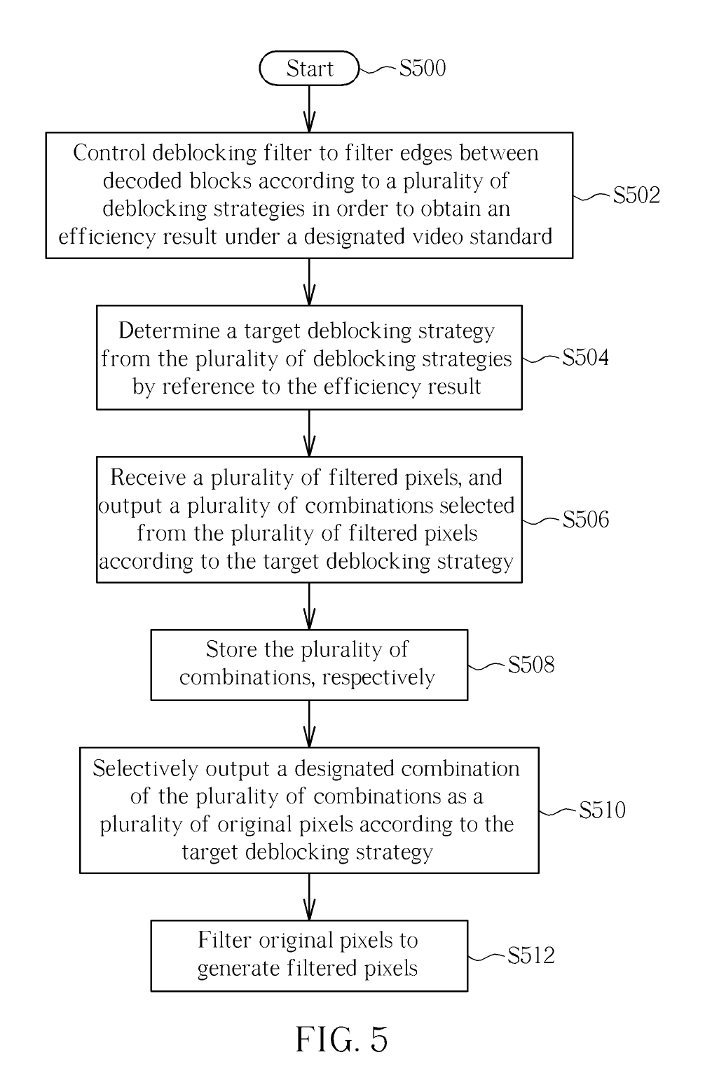

Please refer to FIG. 5. FIG. 5 is a flowchart illustrating a method for controlling a deblocking filter according to an exemplary embodiment of the present invention. Please note that the following steps are not limited to be performed according to the exact sequence shown in FIG. 5 if a roughly identical result can be obtained. The method includes, but is not limited to, the following steps:

Step S500: Start.

Step S502: Control the deblocking filter to filter a plurality of edges between decoded blocks according to a plurality of deblocking strategies in order to obtain an efficiency result under a designated video standard.

Step S504: Determine a target deblocking strategy from the plurality of deblocking strategies by reference to the efficiency result.

Step S506: Receive a plurality of filtered pixels, and output a plurality of combinations selected from the plurality of filtered pixels according to the target deblocking strategy.

Step S508: Store the plurality of combinations, respectively.

Step S510: Selectively output a designated combination of the plurality of combinations as a plurality of original pixels according to the target deblocking strategy.

Step S512: Filter the plurality of original pixels to generate the plurality of filtered pixels.

How each element operates can be known by collocating the steps shown in FIG. 5 and the elements shown in FIG. 2 and FIG. 3, and further description is omitted here for brevity. Be noted that the steps S502 and S504 are executed by the controller 230 (including the controlling unit 310, the calculating unit 320, and the determining unit 330), the step S506 is executed by the first multiplexer module 210, the steps S508 is executed by the plurality of buffers 251˜259 and 261˜263, the step S510 is executed by the second multiplexer module 220, and the step S512 is executed by the edge filter module 240.

Please note that, the steps of the abovementioned flowchart are merely a practicable embodiment of the present invention, and in no way should be considered to be limitations of the scope of the present invention. The method can include other intermediate steps or several steps can be merged into a single step without departing from the spirit of the present invention.

The abovementioned embodiments are presented merely for describing features of the present invention, and in no way should be considered to be limitations of the scope of the present invention. In summary, the present invention provides a deblocking filter and a related controlling method. Since different deblocking strategies have different processing orders for deblocking edges, the combinations CB1˜CBm stored in the plurality of buffers are different from each other when the controller 230 adopts different deblocking strategies to filter the edges. In other words, the chip areas occupied by the buffers as well as the deblocking performance of the deblocking filter 200 will vary depending on different deblocking strategies. By making use of the efficiency result ER to determine the target deblocking strategy DS_target, a goal of saving the chip area of the deblocking filter as well as optimizing the deblocking performance of the deblocking filter can be achieved.

Those skilled in the art will readily observe that numerous modifications and alterations of the device and method may be made while retaining the teachings of the invention.

What is claimed is:

1. A deblocking filter, comprising:
a controller, for controlling the deblocking filter to filter a plurality of edges between decoded blocks according to a plurality of deblocking strategies in order to obtain an efficiency result under a designated video standard, and for determining a target deblocking strategy from the plurality of deblocking strategies by reference to the efficiency result;
an edge filter module, coupled to the controller, for filtering a plurality of original pixels to generate a plurality of filtered pixels;
a first multiplexer module, coupled to the edge filter module and the controller, for receiving the plurality of filtered pixels fed back from the edge filter module, and for outputting a plurality of combinations selected from the plurality of filtered pixels according to the target deblocking strategy;
a plurality of buffers, coupled to the first multiplexer module, for storing the plurality of combinations, respectively; and
a second multiplexer module, coupled to the plurality of buffers, the edge filter module, and the controller, for selectively outputting a designated combination of the plurality of combinations as the original pixels to be inputted into the edge filter module according to the target deblocking strategy.

2. The deblocking filter of claim 1, wherein each of the plurality of deblocking strategies indicates a processing order for deblocking the plurality of edges between the decoded blocks.

3. The deblocking filter of claim 1, wherein the controller comprises:
a controlling unit, for controlling the deblocking filter to filter the plurality of edges between decoded blocks according to the plurality of deblocking strategies under the designated video standard;
a calculating unit, for calculating the efficiency result after the plurality of edges between decoded blocks are filtered according to the plurality of deblocking strategies; and
a determining unit, coupled to the calculating unit, for determining the target deblocking strategy from the plurality of deblocking strategies by reference to the efficiency result.

4. The deblocking filter of claim 1, wherein the plurality of buffers comprise a plurality of buffering units and a plurality of transpose buffering units.

5. The deblocking filter of claim 1, being applied to a multi-format video decoder supporting a plurality of video standards.

6. The deblocking filter of claim 5, wherein the controller determines different target deblocking strategies under the plurality of video standards.

7. The deblocking filter of claim 5, wherein the plurality of video standards comprise an MPEG-2 specification, an MPEG-4 specification, a VC-1 specification, an H.264/AVC specification, a RMVB specification, or an AVS specification.

8. A method for controlling a deblocking filter, comprising steps of:
controlling the deblocking filter to filter a plurality of edges between decoded blocks according to a plurality of deblocking strategies in order to obtain an efficiency result under a designated video standard;
determining a target deblocking strategy from the plurality of deblocking strategies by reference to the efficiency result;
receiving a plurality of filtered pixels, and outputting a plurality of combinations selected from the plurality of filtered pixels according to the target deblocking strategy;
storing the plurality of combinations, respectively;
selectively outputting a designated combination of the plurality of combinations as a plurality of original pixels according to the target deblocking strategy; and
filtering the plurality of original pixels to generate the plurality of filtered pixels.

9. The method of claim 8, wherein each of the plurality of deblocking strategies indicates a processing order for deblocking the plurality of edges between the decoded blocks.

10. The method of claim 8, being applied to a multi-format video decoder supporting a plurality of video standards.

11. The method of claim 10, wherein different target deblocking strategies are determined under the plurality of video standards.

12. The method of claim 10, wherein the plurality of video standards comprise an MPEG-2 specification, an MPEG-4 specification, a VC-1 specification, an H.264/AVC specification, a RMVB specification, or an AVS specification.
